(19) United States
(12) Patent Application Publication
(10) Pub. No.: US 2026/0093930 A1
(43) Pub. Date: Apr. 2, 2026

(54) AUTOMATED PROMPT ENGINEERING PLATFORM

(71) Applicant: SAP SE, Walldorf (DE)

(72) Inventors: Laddie Ji Cheng Tan, Singapore (SG); Kunnan Hong, Singapore (SG); Wen Yang Tan, Singapore (SG); Qixing Chen, Singapore (SG); Zhen Shu, Singapore (SG); Kang Yee Lim, Singapore (SG); Zeling Long, Singapore (SG); Ziyuan Shang, Singapore (SG); Hu Soon Tan, Singapore (SG); Junxiang Jia, Singapore (SG); Alexy Xena Hackmann, Singapore (SG); Sivakumar Sundaresan, Saratoga, CA (US); Anil Ranka, Cupertino, CA (US)

(21) Appl. No.: 18/898,860

(22) Filed: Sep. 27, 2024

(51) Int. Cl. G06F 40/40; G06F 40/174; G06F 40/186

(52) U.S. Cl. CPC G06F 40/40; G06F 40/174; G06F 40/186

(57) ABSTRACT

Methods, systems, and computer-readable storage media for receiving user input defining configuration parameters for a set of prompt templates, providing a configuration file responsive to the user input, processing the configuration file to generate a set of prompts by populating at least one placeholder of each prompt template with at least one input parameter of input parameters groups defined in the configuration file, transmitting the prompts to one or more LLMs, receiving a set of outputs, transmitting a set of metric evaluation prompts to at least one LLM, each metric evaluation prompt being provided using an evaluation prompt template and an output, receiving a set of evaluation results, each evaluation result corresponding to a respective prompt in the set of prompts, and selectively deploying prompt templates in the set of prompt templates for production use in prompting the one or more LLMs.

### BACKGROUND

In the field of artificial intelligence (AI), so-called generative AI (GAI) has recently seen an explosion in popularity. GAI can be described as including so-called foundation models that generate content based on training data. For example, foundation models can include large language models (LLMs), which are a form of GAI that can be used to generate text for a variety of use cases. LLMs have demonstrated remarkable proficiency as general-purpose agents (e.g., chatbots) with extensive capacities for text generation, classification, detection, and the like. For enterprises, these capabilities significantly speed up iterations of applying AI to use cases within enterprise platforms when compared to conventional machine learning (ML) models. However, integrating LLMs into enterprise platforms is a non-trivial task, as LLMs can present various technical challenges and can have disadvantages that have to be managed.

### SUMMARY

Implementations of the present disclosure are directed to an automated prompt engineering platform for time- and resource-efficient provisioning of prompts for large language models (LLMs). More particularly, implementations of the present disclosure are directed to an automated prompt engineering platform that includes a series of configurable components, such as prompt creation from templates and input data, LLM response generation, evaluation, and result aggregation, as well as user interface (UI) support.

In some implementations, actions include receiving user input defining configuration parameters for a set of prompt templates, providing a configuration file responsive to the user input, processing the configuration file to generate a set of prompts by populating at least one placeholder of each prompt template with at least one input parameter of input parameters groups defined in the configuration file, transmitting the prompts in the set of prompts to one or more LLMs, receiving, from the one or more LLMs, a set of outputs, transmitting a set of metric evaluation prompts to at least one LLM, each metric evaluation prompt being provided using an evaluation prompt template and an output, receiving, from the at least one LLM, a set of evaluation results, each evaluation result corresponding to a respective prompt in the set of prompts, and responsive to the set of evaluation results, selectively deploying prompt templates in the set of prompt templates for production use in prompting the one or more LLMs. Other implementations of this aspect include corresponding systems, apparatus, and computer programs, configured to perform the actions of the methods, encoded on computer storage devices.

These and other implementations can each optionally include one or more of the following features: processing the configuration file to generate a set of prompts includes receiving a message from a messaging queue based on a topic assigned to the message, and retrieving the configuration file from a database using an identifier provided with the message; each input parameter group defines at least one input value to populate placeholders of the prompt templates; the configuration file defines a set of metrics for evaluation of outputs of the one or more LLMs; the configuration file identifies the one or more LLMs that are to be prompted using the set of prompts and, for each LLM, defines a set of parameters for execution of the LLM, the set of parameters comprising temperature and maximum number of tokens; prompts in the set of prompts include one or more of reference-free prompts and reference-based prompts; and the configuration file is a YAML Ain′t Markup Language (YAML) file.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure.

FIG. 3 depicts an example user interface (UI) for prompt configuration in accordance with implementations of the present disclosure.

FIGS. 4A and 4B depict example UIs for evaluation results in accordance with implementations of the present disclosure.

FIG. 5 depicts an example process that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are directed to an automated prompt engineering platform for time- and resource-efficient provisioning of prompts for large language models (LLMs). More particularly, implementations of the present disclosure are directed to an automated prompt engineering platform that includes a series of configurable components, such as prompt creation from templates and input data, LLM response generation, evaluation, and result aggregation, as well as user interface (UI) support.

Implementations can include actions of receiving user input defining configuration parameters for a set of prompt templates, providing a configuration file responsive to the user input, processing the configuration file to generate a set of prompts by populating at least one placeholder of each prompt template with at least one input parameter of input parameters groups defined in the configuration file, transmitting the prompts in the set of prompts to one or more LLMs, receiving, from the one or more LLMs, a set of outputs, transmitting a set of metric evaluation prompts to at least one LLM, each metric evaluation prompt being provided using an evaluation prompt template and an output, receiving, from the at least one LLM, a set of evaluation results, each evaluation result corresponding to a respective prompt in the set of prompts, and responsive to the set of evaluation results, selectively deploying prompt templates in the set of prompt templates for production use in prompting the one or more LLMs.

To provide further context for implementations of the present disclosure, and as introduced above, in the field of artificial intelligence (AI), so-called generative AI (GAI) has recently seen an explosion in popularity. GAI can be described as including so-called foundation models that generate content based on training data. For example, foundation models can include LLMs, which are a form of GAI that can be used to generate text for a variety of use cases. LLMs have demonstrated remarkable proficiency as general-purpose agents (e.g., chatbots) with extensive capacities for text generation, classification, detection, and the like. For enterprises, these capabilities significantly speed up iterations of applying AI to use cases within enterprise platforms when compared to conventional machine learning (ML) models.

However, integrating LLMs into enterprise platforms is a non-trivial task. One reason for this is that LLMs can present various technical challenges and can have disadvantages that have to be managed. For example, the effectiveness of an LLM is predominantly reliant on prompts, which are the input to the LLM. Well-constructed and detailed prompts enable the LLM to provide higher quality responses. However, prompts can be relatively complex for many enterprise-level use cases. For example, prompts can involve extensive directives, sophisticated instructions, and input data to provide context for the LLM.

In many use cases, prompts that are to be input to a LLM are generated using prompt templates. In some examples, prompt templates include static input and dynamic input. Here, the static input is the same for each prompt and each invocation of the LLM (each time the LLM is prompted), and the dynamic input includes data dictated by user interaction for each invocation of the LLM. That is, the dynamic input can change for each prompt and each invocation of the LLM. Achieving the desired output from the LLM responsive to the prompts necessitates a high degree of precision. To achieve this, prompt templates are traditionally provisioned through a time- and resource-consuming cycle of trial and error. Presently, the optimization of prompt templates requires substantial consumption of resources including technical resources (processors, memory, bandwidth).

In further detail, the engineering lifecycle for prompt design is a crucial but monotonous and repetitive process in the development and maintenance of the LLM applications. This lifecycle typically encompasses several stages, starting with the identification of requirements for the application. Traditionally, various prompts that meet the defined requirements are manually crafted with a goal of ensuring that LLMs can process the inputs while delivering accurate and relevant outputs. Subsequent phases include rigorous testing for each prompt using various sets of input data and model parameters to verify the quality, accuracy, bias, and consistency of the responses from the LLMs. However, significant challenges arise in maintaining traceability of modifications and, importantly, in understanding the impact that specific adjustments to the prompts have on the behavior of the LLMs, which adds complexity to the process.

The entire process of testing, evaluation, and refinement often necessitates repeated rounds of testing with updated prompts or model parameters to ensures that the LLM application remains effective and reliable. Continuous monitoring is also essential to capture and address new issues and/or to adapt to changes in language use over time. However, the repetitive and labor-intensive nature of this manual process could be optimized to enhance both efficiency and effectiveness in the development of LLM applications.

In view of the above context, implementations of the present disclosure provide an automated prompt engineering platform for time- and resource-efficient provisioning of prompts for LLMs. As described in further detail herein, the automated prompt engineering platform of the present disclosure simplifies, streamlines, and scales prompt engineering processes. In some implementations, the automated prompt engineering platform includes a series of configurable components, such as prompt creation from templates and input data, LLM response generation, evaluation, and result aggregation, as well as UI support. To extend the versatility and usability of the automated prompt engineering platform, multiple, disparate prompts can be defined in a single configuration file and can be designed to accommodate the diverse requirements of different use cases. In some examples, the configuration file is provided using YAML Ain′t Markup Language (YAML), which can be described as a human-readable, computer-processable data serialization language.

Implementations of the present disclosure are described in further detail herein with non-limiting reference to applications, systems, components, platforms, and the like that are provisioned by SAP SE of Walldorf, Germany. It is contemplated, however, that implementations of the present disclosure can be realized using any appropriate applications, systems, components, platforms, and the like.

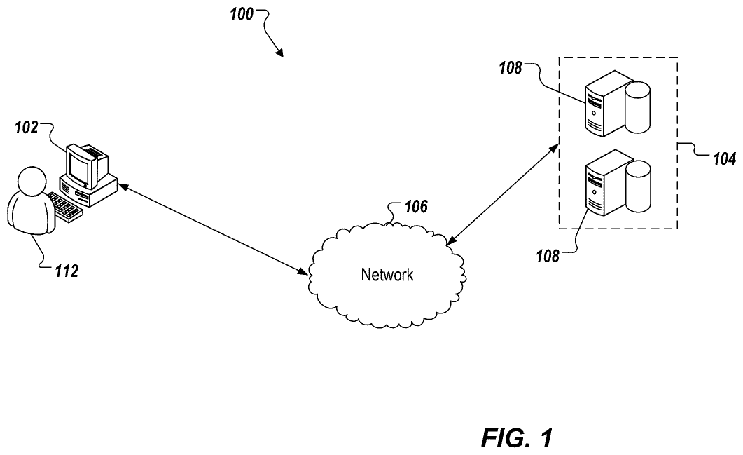

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106). In accordance with implementations of the present disclosure, and as noted above, the server system 104 can host an automated prompt engineering platform for time- and resource-efficient provisioning of prompts for LLMs, as described in further detail herein.

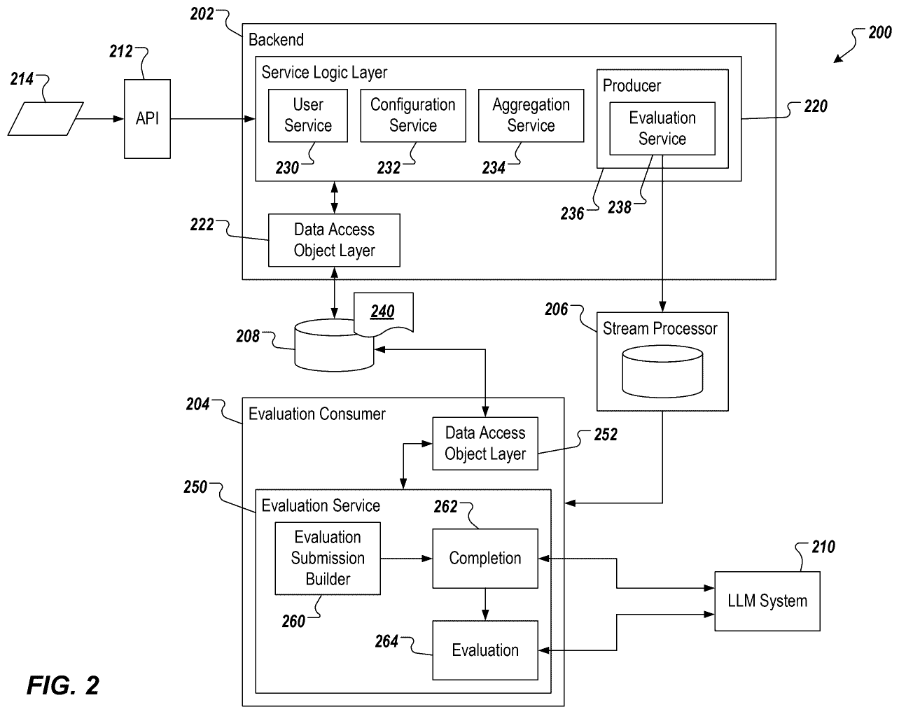

FIG. 2 depicts an example conceptual architecture 200 in accordance with implementations of the present disclosure. In the depicted example, the conceptual architecture 200 includes a backend 202, an evaluation consumer 204, a stream processor 206, a database 208, a LLM system 210, and an application programming interface (API) 212. As described in further detail herein, input 214 is received and is processed as described in further detail herein. In some examples, the database 208 is provided as an object-relational database management system, such as PostgreSQL. In some examples, the LLM system 210 represents one or more third-party systems that host multiple, disparate LLMs.

In the example of FIG. 2, the backend 202 includes a service logic layer 220 and a data access object layer 222. The service logic layer 220 includes a user service 230, a configuration service 232, an aggregation service 234, and a producer 236. The producer 236 includes an evaluation service 238. As described in further detail herein, the evaluation service 238 provides a configuration file 240 (e.g., YAML file) for evaluating prompts. In the example of FIG. 2, the evaluation consumer 204 includes an evaluation service 250 and a data access object layer 252. The evaluation service 250 includes an evaluation submission builder 260, a completion module 262, and an evaluation module 264.

In some examples, the example conceptual architecture 200, or at least portions thereof, can be implemented on top of the SAP Business Technology Platform (BTP) and authentication can be provided using SAP Cloud Identity Service. In some examples, UIs are provided in Typescript on basis of the React framework with SAP UI5 components. The automated prompt engineering platform can be deployed in the SAP BTP Cloud Foundry Runtime. One or more backend components can be provided in Python, utilising the FastAPI framework to expose APIs, such as the API 212. In some examples, Postgres can be used for database management and Apache Kafka can be used to manage message queues. External services can be deployed in the SAP BTP. In some examples, each of the LLMs available for inferencing by the automated prompt engineering platform are deployed and hosted on SAP AI Core, which is a service in the SAP BTP for handling the execution and operation of AI assets in a standardised, scalable, and hyperscaler-agnostic way.

In further detail, incorporating a messaging system, such as Apache Kafka, improves fault tolerance and scalability, which are vital attributes considering that LLMs frequently encounter latency in producing results and responses. Furthermore, to enhance user experience (UX), the evaluation of prompt engineering is designed asynchronously. This approach employs server-side events, enabling users to leave the page where they initiated the prompt engineering evaluation while the evaluation continues to be processed in the backend. Further, using a relational database management system, such as the Postgres database, for version control enables storage of multiple configurations tailored to various enterprise-level use cases. This configuration also guarantees the persistence of evaluation results. Additionally, this feature provides traceability, enabling users to monitor changes and configurations over time.

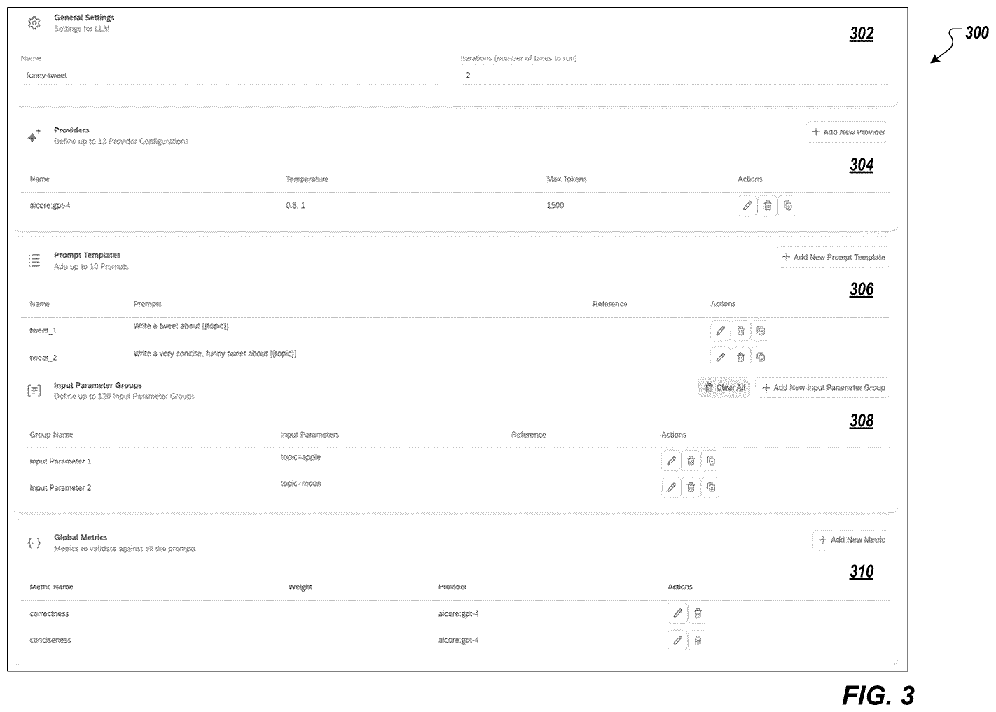

As described in further detail herein, the input 214 is received through the API 212 for processing. In some implementations, the input 214 is generated by one or more users (e.g., the user 112 of FIG. 1) using one or more UIs. FIG. 3 depicts an example UI 300 for prompt configuration and request submission in accordance with implementations of the present disclosure. The UI 300 is designed to guide users through a systematic process of entering various configurations for each of the steps required for prompt testing automation. The UI enables users to upload input data in comma separated value (CSV) format. As described in further detail herein, users can interact with the UI 300 to select metrics to assess the quality of user-provided prompts, choosing from pre-defined metrics and/or user-customized metrics based on user-defined criteria. The settings configured in the UI 300 are converted into a configuration file (YAML file) for processing.

In the example of FIG. 3, the UI 300 includes a general settings UI 302, a provider UI 304, a prompt template UI 306, an input parameter groups UI 308, and a global metrics UI 310.

In some examples, the general settings UI 302 enables a user to name a prompt engineering project and to define a number of iterations (e.g., number of times each prompt is submitted to each LLM). In some examples, the provider UI 304 enables the user to select one or more LLMs provisioned by one of more third-party providers as well as setting operating parameters for each LLM. Example parameters include temperature (e.g., that influences the LLM's output by determining whether the output is more random and creative (higher temperature) or more predictable (lower temperature) and maximum number of tokens (e.g., constraining the total number of tokens for both the prompt input to the LLM and the output tokens generated by the LLM in response to the prompt).

In some examples, the prompt template UI 306 enables the user to define one or more prompt templates that are to be evaluated. Non-limiting, example prompt templates depicted in FIG. 3 include:
Write a tweet about {{topic}}
Write a very concise, funny tweet about {{topic}}
   In these examples, the text between the brackets {{ }} is dynamic input and the remaining text is static input. In some examples, the input parameter groups UI 308 enables the user to define input parameters that can be used to populate the dynamic input of each of the prompt templates to define a prompt. Continuing with the example prompt templates above and the example input parameter groups of FIG. 3, non-limiting, example prompts include:
Write a tweet about apple
Write a tweet about moon
Write a very concise, funny tweet about apple
Write a very concise, funny tweet about moon

In some examples, the global metrics UI 310 enable the user to define metrics for evaluating each of the prompts submitted to the LLM(s). Perhaps, more accurately, the metrics can be used to evaluate the responses of the LLM(s) to the prompts. However, and as discussed herein, performance of a LLM is correlated to characteristics of the prompts (e.g., quality). Example metrics can include correctness (e.g., degree of factual correctness of response based on some ground truth) and conciseness (e.g., degree of length of response). Other example metrics can include, but are not limited to, groundedness, sentiment, BLEU score, ROUGE score, BERT score, and user-defined, custom metrics.

Referring again to FIG. 2, the input 214 is received from a user through one or more UIs, such as the UI 300 of FIG. 3. In some examples, the user service 230 receives the input 214. The input 214 is provided to the configuration service 232, which processes the input 214 to define the configuration file 240 (e.g., YAML file). For example, the configuration service 232 populates a configuration template using the input 214. In some examples, the configuration file 240 is stored in the database 208, which the service logic layer 220 communicates with through the data access object layer 222.

In some implementations, the producer 236 triggers evaluation of a set of prompts based on the configuration file 240. For example, in response to a user request to evaluate the prompts configured in the configuration file 240, the evaluation service inserts a message to the stream processor 206 (e.g., Apache Kafka). In some examples, the message includes a topic (e.g., configuration) and an identifier that uniquely identifies the configuration file 240. In some implementations, the evaluation consumer 204 subscripts to the topic with the stream processor 206. In this manner, the evaluation consumer 204 can retrieve messages that indicate the topic.

In some implementations, in response to the message, the evaluation service 250 retrieves the configuration file 240 (e.g., through the data access object layer 252) based on the identifier provided in the message. In some examples, the evaluations submission builder 260 generates the set of prompts by, for example, populating the prompt templates with the input parameters defined in the configuration file 240. In some examples, for the prompts in the set of prompts, one or more LLMs that are to process the prompts and provide outputs are identified. In some examples, the completion module 262 submits each prompt in the set of prompts to a respective LLM in the LLM system 210 (e.g., through an API).

The one or more LLMs of the LLM system 210 process the prompts in the set of prompts and, for each prompt, returns an output that is responsive to the prompt to the completion module 262. In some examples, the completion module 262 provides a set of evaluation pairs, each evaluation pair including a prompt and the output that was generated responsive to the prompt. The completion module 262 provides the set of evaluation pairs to the evaluation module 264, which provides a metric evaluation prompt for each evaluation pair. The evaluation module 264 submits each metric evaluation prompt to a LLM in the LLM system 210 (e.g., through an API). The LLM processes the metric evaluation prompts and returns (to the evaluation module 264) an evaluation result for each metric evaluation prompt. In some examples, the evaluation results are stored in the database 208.

In some implementations, the aggregation service 234 retrieves the evaluation results from the database 208 and performs aggregation functions thereon. In some examples, one or more UIs are provided to enable the user to view the evaluation results and aggregations, as described in further detail herein.

In accordance with implementations of the present disclosure, and as discussed above with reference to FIG. 2, user input to define prompt templates, input parameter groups, etc. (e.g., through the UI 300 of FIG. 3) are packaged into a configuration file (e.g., the configuration file 240 of FIG. 2). Example content of the configuration file can include name of the test case, providers (LLM names specifying the LLMs utilized for generating outputs and conduct evaluation), prompt templates, input data used to populate the prompt templates, reference (ground truth to which an LLM output is compared), and metrics (the criteria used to score output of the LLM(s)). In some examples, reference-free evaluation and reference-based evaluation are provided, as described in further detail herein.

Continuing with the examples above, example content of the configuration file for reference-free evaluation can be provided as:

Listing 1: Example Content of Configuration File (Reference-Free)

```
name: “funny-tweet”
providers:
  - name: “aicore:gpt-4”
    temperatures: [0.8, 1.0]
    max_tokens: 1500
sample: 2
prompts:
  - name: “prompt 1”
    prompt: “Write a tweet about {{topic}}”
  - name: “prompt 2”
    prompt: “Write a very concise, funny tweet about {{topic}}”
    sample: 3
parameter_groups:
  - parameters:
      topic: “apple”
  - parameters:
      topic: “moon”
metrics:
  - name: correctness
    provider: “aicore:gpt-4”
    max_tokens: 2048
    temperature: 0.2
  - name: conciseness
    provider: “aicore:gpt-4”
    max_tokens: 2048
    temperature: 0.2
  - name: custom-authenticity
```

Continuing with the examples above, example content of the configuration file for reference-based evaluation can be provided as:

Listing 2: Example Content of Configuration
File (Reference-Based)

```
name: “concise-tweet-with-ref”
providers:
  - name: “aicore:gpt-4”
    temperatures: [0.8, 1.0]
    max_tokens: 1500
prompts:
  - name: “prompt 1”
    prompt: “Write a tweet about {{topic}}”
  - name: “prompt 2”
    prompt: “Write a very concise, funny tweet about {{topic}}”
parameter_groups:
    - parameters:
        topic: “digestion”
        theme: “funny”
      reference: “Did you know that your body has its own built-
in food processor? Digestion is the process by which your body
breaks down the nutrients in the food you eat into smaller
molecules that can be absorbed and used for energy. #digestion”
    - parameters:
        topic: “the moon”
        theme: “sad”
      reference: “As I am looking at the full moon tonight, I
think of you... #lonely #missingyou”
metrics:
  - name: groundedness
    provider: “aicore:gpt-4”
  - name: conciseness
    provider: “aicore:gpt-4”
  - name: creativity
```

In some examples, the “name” key in the configuration file identifies the specified configuration and is unique for each user. Typically, the name assigned will correspond to the LLM application that the user is developing. Table 1 depicts an example provider platform and names of supported LLMs.

TABLE 1
Example LLMs

| Provider | |
|---|---|
| Platform | LLMs |
| SAP BTP | gpt-4, gpt-35-turbo, gpt-4-32k, tiiuae--falcon-40b- |
| AI Core | instruct, gpt-35-turbo-16k, gpt-35-turbo-0613, gpt-35- |
| | turbo-0125, text-bison, chat-bison, gemini-1.0-pro |

These are options from which the “providers” parameter is to be defined through configuration. In some examples, for each provider, the user can specify a model, max number of tokens, and a list of temperatures, as discussed above. In some examples, default values can be provided (e.g., 1.0 for temperature and 1028 for max tokens). In some examples, LLMs of multiple providers are supported, allowing for the selection of more than one LLM to conduct evaluation. An example of providers using both GPT-3.5-Turbo and GPT-4 to generate the output under evaluation can be provided as:

### Providers:

Listing 3: Example Providers and Parameters

```
- name: “aicore:gpt-4”
    temperatures: [0.8, 1.0]
    max_tokens: 1500
  - name: “aicore:gpt-35-turbo”
    temperatures: [0.8, 1.0]
    max_tokens: 1500
```

Implementations of the present disclosure enable users to define multiple prompt templates for testing within a single configuration file. Listing 4, below, depicts an example prompts portion of a configuration file with two prompts respectively identified as “prompt 1” and “prompt 2”:

Listing 4: Example Portion of Configuration File

```
prompts:
  - name: “prompt 1”
    prompt: “Write a tweet about {{topic}}”
  - name: “prompt 2”
    prompt: “Write a very concise, {{theme}} tweet about
{{topic}}”
    sample: 3
parameter_groups:
    - parameters:
      topic: “digestion”
      theme: “funny”
```

As introduced above, implementations of the present disclosure enable users to insert placeholders in the prompt templates (e.g., marked by double braces, {{ }}). These placeholders will be automatically replaced with corresponding parameters from the parameter groups during execution. As an example, a parameter group carrying placeholders of “topic” and “theme” assigned with respective values “digestion” and “funny” are shown in the example of Listing 4.

Certain evaluation metrics (e.g., groundedness, similarity) require comparison of the results to a set of ground truths, which can be referred to as references. A reference can be linked to a prompt or a set of parameters depending on requirements of the use case(s). If prompts have no placeholder for input parameters, references will be directly linked to prompts, as represented in the example of Listing 5:

Listing 5: Example Prompt Configuration w/o
Parameter Placeholders and w/ References

```
prompts:
  - name: “prompt 1”
    prompt: “Write a sad tweet about the moon.”
    reference: “As I am looking at the full moon tonight, I think
of you... #lonely #missingyou”
  - name: “prompt 2”
    prompt: “Write a very concise, funny tweet about digestion.”
    reference: “Did you know that your body has its own built-in
food processor? Digestion is the process by which your body
breaks down the nutrients in the food you eat into smaller
molecules that can be absorbed and used for energy. #digestion”
```

If input parameters are employed, they will have references linked thereto, as represented in the example of Listing 6:

Listing 6: Example Prompt Configuration
w/ Parameter Placeholders and References

```
prompts:
  - name: “prompt 1”
    prompt: “Write a tweet about {{topic}}”
  - name: “prompt 2”
    prompt: “Write a very concise, funny tweet about {{topic}}”
parameter_groups:
    - parameters:
        topic: “digestion”
        theme: “funny”
      reference: “Did you know that your body has its own built-
in food processor? Digestion is the process by which your body
breaks down the nutrients in the food you eat into smaller
molecules that can be absorbed and used for energy. #digestion”
    - parameters:
        topic: “the moon”
        theme: “sad”
      reference: “As I am looking at the full moon tonight, I
think of you... #lonely #missingyou”
```

In some examples, for metrics that produce an integer or float value representing an evaluation score, weight percentages can be allocated. By default, metrics that return numeric values are given equal weighting. An example of configured metrics in a configuration file can be provided as:

Listing 7: Example Metric Configuration

```
Metrics:
  - name: correctness
    provider: “aicore:gpt-4”
    max_tokens: 2048
    temperature: 0.2
    weightage: 0.2
  - name: conciseness
    provider: “aicore:gpt-4”
    max_tokens: 2048
    temperature: 0.2
    weightage: 0.3
  - name: custom-authenticity
    weightage: 0.5
```

By provisioning of custom metrics, users are given the flexibility to formulate metrics that meet their specific needs. Custom metrics usually leverage a relatively strong LLM as an evaluator (evaluator LLM). Similar to using LLMs for output generation, the evaluator LLM is defined using a provider parameter. In some examples, a custom metric can be registered through an API by submitting information such as the evaluation prompt, its output type and whether it requires reference. An example of a Javacript object notation (JSON) payload is provided as:

Listing 8: JSON Payload for Custom LLM Metric Registration API

```
{
  “metric_name”: “clearness-score”,
  “eval_type”: “llm”,
  “required_prompt”: true,
  “eval_prompt”: “Your task is to rate the tweet on
{{theme}} is given on how clear it is. Respond only as a
number from 0-10 where 0 is the least clear and 10 is the
clearest. An example of a clear tweet is the following:
{{reference}}”,
  “required_reference”: false,
  “output_type”: “numeric”,
}
```

In accordance with implementations of the present disclosure, evaluation of prompts includes retrieving a configuration file that embodies configuration setting defined by the user, as described herein. A set of prompts is generated, each prompt being specific to an identified (from the configuration file) LLM. Each prompt in the set of prompts is submitted to a LLM, and the LLM provides an output that is responsive to the prompt. By way non-limiting example, an example prompt and responsive output can be provided as:
Prompt: write a tweet about apple
Response: An apple a day keeps the doctor away #quote
   In some examples, a set of evaluation pairs is provided, each evaluation pair including a prompt and an output. For each evaluation pair, a metric evaluation prompt is generated using, for example, an evaluation prompt template. A non-limiting example evaluation prompt template can be provided as:
Please act as an impartial judge and evaluate the quality of responses provided by an AI assistant. Is the response correct, accurate, and factual?
   In some examples, the metric evaluation prompt includes the evaluation prompt template and an evaluation pair. In some implementations, the metric evaluation prompt is input to an evaluation LLM, which processes the metric evaluation prompt to generate an evaluation result, which is returned. In some examples, the evaluation result include scores for respective metrics (e.g., correctness score=0.9) and a set of statistics (e.g., latency, prompt token count, prompt cost (in terms of processors, memory), and output token count).

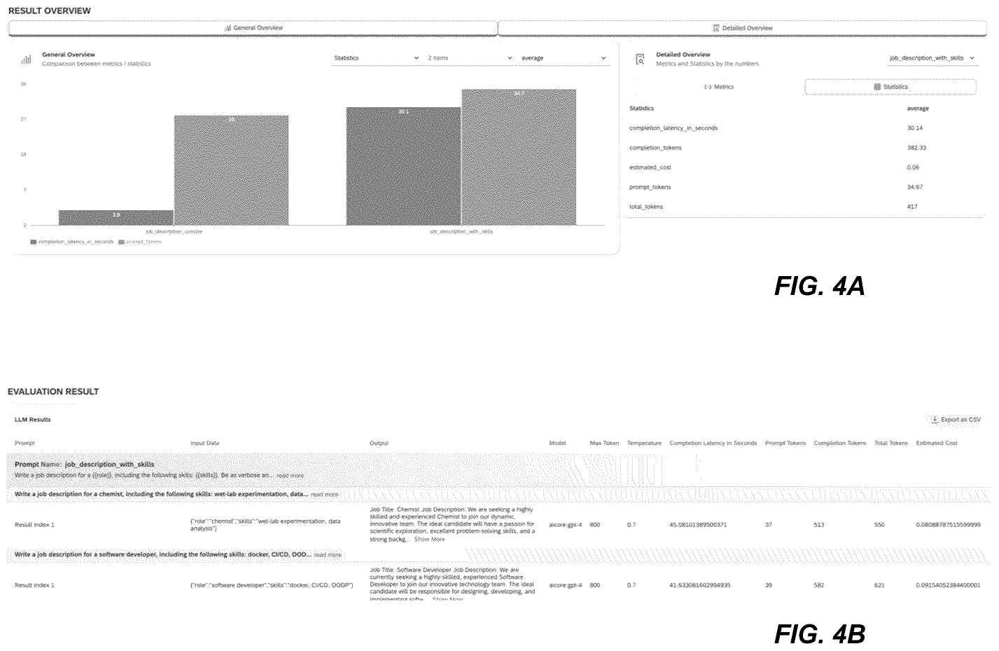

After evaluation results are returned, users can access and view the evaluation results. FIGS. 4A and 4B depict example UIs for evaluation results in accordance with implementations of the present disclosure. FIG. 4A depicts an example results overview UI 400 and FIG. 4B depicts an example evaluation result UI 402. The evaluation results can be displayed in tabular format for ease in comparing statistics and metrics across all submitted prompts. In some examples, an aggregation function enables users to compile results based on averages, standard deviations, rankings, and like. Aggregations can be displayed on one or more dashboards featuring graphs and any appropriate visualizations for visualizing the statistics and metrics. The results overview UI 400 depicts an example of the aggregation feature and the evaluation results UI 402 examples of detailed results corresponding to every request index and each input parameter across various prompt templates.

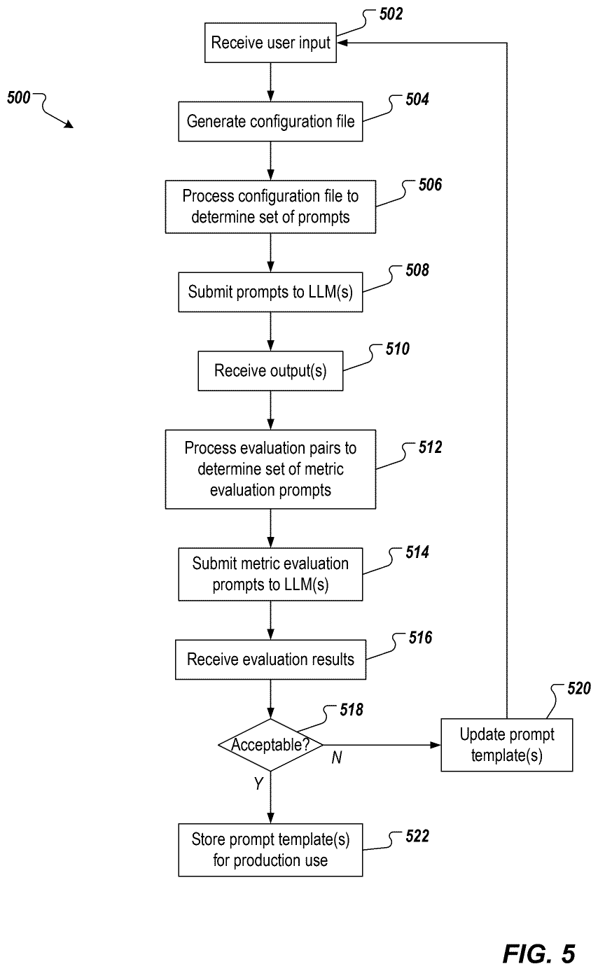

FIG. 5 depicts an example process 500 that can be executed in accordance with implementations of the present disclosure. In some examples, the example process 500 is provided using one or more computer-executable programs executed by one or more computing devices. In some examples, the example process 500 is representative of batch-based optimization.

User input is received (502). For example, and as described herein with reference to FIG. 2, the user service 230 receives the input 214. A configuration file is generated (504). For example, and as described herein, the input 214 is provided to the configuration service 232, which processes the input 214 to define the configuration file 240 (e.g., YAML file). For example, the configuration service 232 populates a configuration template using the input 214. In some examples, the configuration file 240 is stored in the database 208, which the service logic layer 220 communicates with through the data access object layer 222.

The configuration file is processed to determine a set of prompts (506). For example, and as described herein, the producer 236 triggers evaluation of a set of prompts based on the configuration file 240. For example, in response to a user request to evaluate the prompts configured in the configuration file 240, the evaluation service inserts a message to the stream processor 206 (e.g., Apache Kafka). In some examples, the message includes a topic (e.g., configuration) and an identifier that uniquely identifies the configuration file 240. In some implementations, the evaluation consumer 204 subscripts to the topic with the stream processor 206. In this manner, the evaluation consumer 204 can retrieve messages that indicate the topic. In some implementations, in response to the message, the evaluation service 250 retrieves the configuration file 240 (e.g., through the data access object layer 252) based on the identifier provided in the message. In some examples, the evaluations submission builder 260 generates the set of prompts by, for example, populating the prompt templates with the input parameters defined in the configuration file 240.

The prompts are submitted to one or more LLMs (508) and respective outputs are received (510). For example, and as described herein, for the prompts in the set of prompts, one or more LLMs that are to process the prompts and provide outputs are identified. In some examples, the completion module 262 submits each prompt in the set of prompts to a respective LLM in the LLM system 210 (e.g., through an API). The one or more LLMs of the LLM system 210 process the prompts in the set of prompts and, for each prompt, returns an output that is responsive to the prompt to the completion module 262.

Evaluation pairs are processed to determine a set of metric evaluation prompts (512) that are submitted to one or more LLMs (514) and evaluation results are received (516). For example, and as described herein, the completion module 262 provides a set of evaluation pairs, each evaluation pair including a prompt and the output that was generated responsive to the prompt. The completion module 262 provides the set of evaluation pairs to the evaluation module 264, which provides a metric evaluation prompt for each evaluation pair. The evaluation module 264 submits each metric evaluation prompt to a LLM in the LLM system 210 (e.g., through an API). The LLM processes the metric evaluation prompts and returns (to the evaluation module 264) an evaluation result for each metric evaluation prompt. In some examples, the evaluation results are stored in the database 208. In some implementations, the aggregation service 234 retrieves the evaluation results from the database 208 and performs aggregation functions thereon. In some examples, one or more UIs are provided to enable the user to view the evaluation results and aggregations

For each prompt template in the configuration file, it is determined whether the prompt template is acceptable (518). For example, the user can review the evaluation results and aggregations (e.g., through the UIs 400, 402) to determine whether the prompt templates induce acceptable outputs of the LLMs and/or acceptable performance (e.g., in terms of technical resources consumed in processing of prompts generated using the prompt templates). For each prompt template that is determined not to be acceptable, the prompt template is updated (520). For example, the user can change the prompt templated and/or adjust one or more other configuration parameters. For each prompt template that is determined to be acceptable, the prompt template is stored for production use (522). For example, and as described herein, the prompt template can be released to a production environment, in which the prompt template is used during the performance of enterprise operations.

Implementations of the present disclosure provide multiple technical improvements. For example, the automated prompt engineering platform of the present disclosure improves prompt engineering by automating the laborious, repetitive, and time-consuming tasks that previously bogged down professionals in this domain. In some examples, the architecture of the automated prompt engineering platform leverages asynchronous message queues to eliminate dependencies on sequential interactions. This feature not only speeds up operations, but also enhances UX through facilitating simultaneous evaluations (e.g., concurrent evaluation of multiple prompts). In some examples, the architecture incorporates a persistent layer that precisely manages and tracks changes in user-defined configurations. This feature offers users the ability to revisit and analyse historical setup data and modifications. Further, the automated prompt engineering platform of the present disclosure provides user-friendly UIs designed to accommodate both technical and non-technical users. The UIs simplify the construction of configuration and assists users in distilling the results into aggregated graphics and table presentations, for example. Such features enable users to quickly extract valuable insights from the performance results associated with a huge number of combinations of prompt templates, input data, large language models, and configurable parameters. In general, the automated prompt engineering platform of the present disclosure is an effective tool to enhance the management and execution of prompt testing and bridge the gap between the iteration of product quality and rapid requirement changes emerging from GAI development.

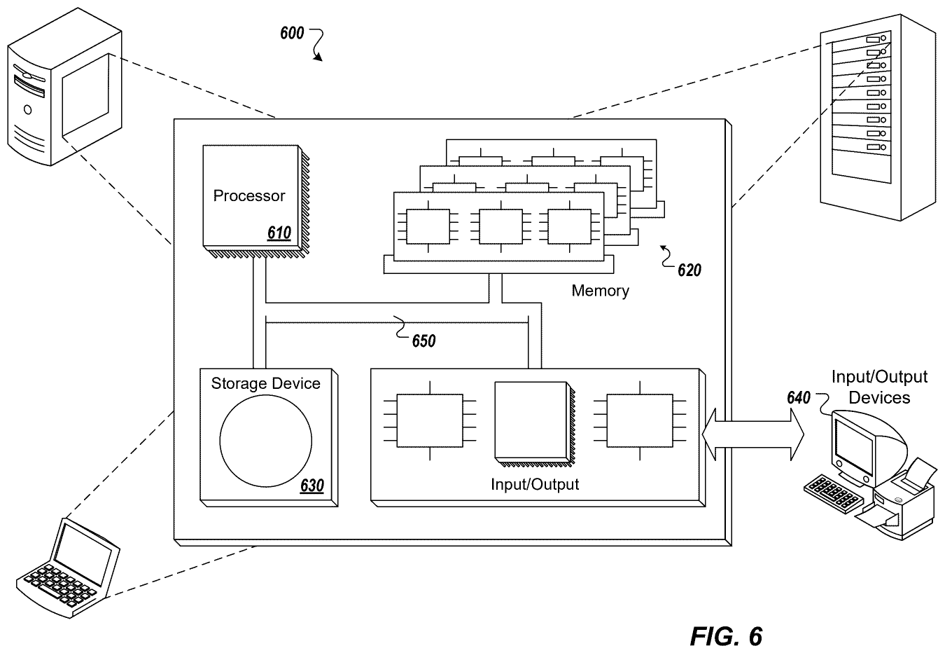

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for engineering of prompt templates for prompting large language models (LLMs), the method being executed by one or more processors and comprising:
receiving user input defining configuration parameters for a set of prompt templates;
providing a configuration file responsive to the user input;
processing the configuration file to generate a set of prompts by populating at least one placeholder of each prompt template with at least one input parameter of input parameters groups defined in the configuration file;
transmitting the prompts in the set of prompts to one or more LLMs;
receiving, from the one or more LLMs, a set of outputs;
transmitting a set of metric evaluation prompts to at least one LLM, each metric evaluation prompt being provided using an evaluation prompt template and an output;
receiving, from the at least one LLM, a set of evaluation results, each evaluation result corresponding to a respective prompt in the set of prompts; and
responsive to the set of evaluation results, selectively deploying prompt templates in the set of prompt templates for production use in prompting the one or more LLMs.

2. The method of claim 1, wherein processing the configuration file to generate a set of prompts comprises:
receiving a message from a messaging queue based on a topic assigned to the message; and
retrieving the configuration file from a database using an identifier provided with the message.

3. The method of claim 1, wherein each input parameter group defines at least one input value to populate placeholders of the prompt templates.

4. The method of claim 1, wherein the configuration file defines a set of metrics for evaluation of outputs of the one or more LLMs.

5. The method of claim 1, wherein the configuration file identifies the one or more LLMs that are to be prompted using the set of prompts and, for each LLM, defines a set of parameters for execution of the LLM, the set of parameters comprising temperature and maximum number of tokens.

6. The method of claim 1, wherein prompts in the set of prompts comprise one or more of reference-free prompts and reference-based prompts.

7. The method of claim 1, wherein the configuration file comprises a YAML Ain′t Markup Language (YAML) file.

8. A non-transitory computer-readable storage medium coupled to one or more processors and having instructions stored thereon which, when executed by the one or more processors, cause the one or more processors to perform operations for engineering of prompt templates for prompting large language models (LLMs), the operations comprising:
receiving user input defining configuration parameters for a set of prompt templates;
providing a configuration file responsive to the user input;
processing the configuration file to generate a set of prompts by populating at least one placeholder of each prompt template with at least one input parameter of input parameters groups defined in the configuration file;
transmitting the prompts in the set of prompts to one or more LLMs;
receiving, from the one or more LLMs, a set of outputs;
transmitting a set of metric evaluation prompts to at least one LLM, each metric evaluation prompt being provided using an evaluation prompt template and an output;
receiving, from the at least one LLM, a set of evaluation results, each evaluation result corresponding to a respective prompt in the set of prompts; and
responsive to the set of evaluation results, selectively deploying prompt templates in the set of prompt templates for production use in prompting the one or more LLMs.

9. The non-transitory computer-readable storage medium of claim 8, wherein processing the configuration file to generate a set of prompts comprises:
receiving a message from a messaging queue based on a topic assigned to the message; and
retrieving the configuration file from a database using an identifier provided with the message.

10. The non-transitory computer-readable storage medium of claim 8, wherein each input parameter group defines at least one input value to populate placeholders of the prompt templates.

11. The non-transitory computer-readable storage medium of claim 8, wherein the configuration file defines a set of metrics for evaluation of outputs of the one or more LLMs.

12. The non-transitory computer-readable storage medium of claim 8, wherein the configuration file identifies the one or more LLMs that are to be prompted using the set of prompts and, for each LLM, defines a set of parameters for execution of the LLM, the set of parameters comprising temperature and maximum number of tokens.

13. The non-transitory computer-readable storage medium of claim 8, wherein prompts in the set of prompts comprise one or more of reference-free prompts and reference-based prompts.

14. The non-transitory computer-readable storage medium of claim 8, wherein the configuration file comprises a YAML Ain′t Markup Language (YAML) file.

15. A system, comprising:
a computing device; and
a computer-readable storage device coupled to the computing device and having instructions stored thereon which, when executed by the computing device, cause the computing device to perform operations for engineering of prompt templates for prompting large language models (LLMs), the operations comprising:
receiving user input defining configuration parameters for a set of prompt templates,
providing a configuration file responsive to the user input,
processing the configuration file to generate a set of prompts by populating at least one placeholder of each prompt template with at least one input parameter of input parameters groups defined in the configuration file,
transmitting the prompts in the set of prompts to one or more LLMs,
receiving, from the one or more LLMs, a set of outputs,
transmitting a set of metric evaluation prompts to at least one LLM, each metric evaluation prompt being provided using an evaluation prompt template and an output,
receiving, from the at least one LLM, a set of evaluation results, each evaluation result corresponding to a respective prompt in the set of prompts, and
responsive to the set of evaluation results, selectively deploying prompt templates in the set of prompt templates for production use in prompting the one or more LLMs.

16. The system of claim 15, wherein processing the configuration file to generate a set of prompts comprises:
receiving a message from a messaging queue based on a topic assigned to the message; and
retrieving the configuration file from a database using an identifier provided with the message.

17. The system of claim 15, wherein each input parameter group defines at least one input value to populate placeholders of the prompt templates.

18. The system of claim 15, wherein the configuration file defines a set of metrics for evaluation of outputs of the one or more LLMs.

19. The system of claim 15, wherein the configuration file identifies the one or more LLMs that are to be prompted using the set of prompts and, for each LLM, defines a set of parameters for execution of the LLM, the set of parameters comprising temperature and maximum number of tokens.

20. The system of claim 15, wherein prompts in the set of prompts comprise one or more of reference-free prompts and reference-based prompts.
